(19) United States
(12) Patent Application Publication
(10) Pub. No.: US 2024/0187494 A1
(43) Pub. Date: Jun. 6, 2024

(54) Network Nodes and Methods Therein for Facilitating Application Context Relocation

(71) Applicant: Telefonaktiebolaget LM Ericsson (publ), Stockholm (SE)

(72) Inventor: Wenliang Xu, Shanghai (CN)

(21) Appl. No.: 18/285,509

(22) PCT Filed: Mar. 31, 2022
(86) PCT No.: PCT/CN2022/084303

§ 371 Date: Oct. 4, 2023

(30) Foreign Application Priority Data
Apr. 7, 2021 (WO) PCT/CN2021/085822

(51) Int. Cl. H04L 67/51; H04L 67/10

(52) U.S. Cl. CPC H04L 67/51; H04L 67/10

(57) ABSTRACT

The present disclosure provides a method (600) in a source Edge Application Server, EAS. The method (600) includes: transmitting (610) a request for EAS discovery to a source Edge Enabler Server, EES: receiving (620), from the source EES, a response containing information indicating one or more discovered EASs: determining or selecting (630) one of the one or more discovered EASs as a target EAS: and transmitting (640) information indicating the selected target EAS to the source EES.

### CROSS-REFERENCE TO RELATED APPLICATION(S)

This application claims priority to the PCT International Application No. PCT/CN2021/085822, entitled “NETWORK NODES AND METHODS THEREIN FOR FACILITATING APPLICATION CONTEXT RELOCATION”, filed on Apr. 7, 2021, which is incorporated herein by reference in its entirety.

### TECHNICAL FIELD

The present disclosure relates to communication technology, and more particularly, to network nodes and methods therein for facilitating Application Context Relocation (ACR).

### BACKGROUND

The 3rd Generation Partnership Project (3GPP) Technical Specification (TS) 23.558, V2.0.0, which is incorporated herein by reference in its entirety, specifies the application layer architecture, procedures and information flows for enabling edge applications over 3GPP networks. It includes architectural requirements for enabling edge applications, application layer architecture fulfilling the architecture requirements, and procedures to enable the deployment of edge applications.

FIG. 1 shows an architecture for enabling edge applications. As shown, an Edge Data Network (EDN) is a local data network. One or more Edge Application Servers (EASs) and one or more Edge Enabler Servers (EESs) are contained within the EDN. An Edge Configuration Server (ECS) provides configurations related to the EES(s), including details of the EDN hosting the EES(s). A User Equipment (UE) contains one or more Application Clients and an Edge Enabler Client (EEC). The EAS(s), the EES, and the ECS may interact with a 3GPP Core Network.

FIG. 1 also shows reference points used in the architecture, among which the EDGE-3 reference point enables interactions between the EES and the EASs. The EDGE-3 reference point can support:
a) registration of EASs with availability information (e.g. time constraints, location constraints);
b) de-registration of EASs from the EES;
c) discovery of Target EAS (T-EAS) information to support application context transfer;
d) providing access to network capability information (e.g., location information, Quality of Service (QOS) related information); and
e) requesting the setup of a data session between AC and EAS with a specific QoS.

The EDGE-9 reference point enables interactions between two EESs. The EDGE-9 reference point may be provided between EESs in different EDN, as shown in FIG. 2A, or within the same EDN, as shown in FIG. 2B. The EDGE-9 reference point can support:
a) discovery of T-EAS information to support ACR; and
b) EEC context retrieval and relocation procedures.

The ACR may be decided by different entities in the edge application architecture. FIG. 3 shows a Source EAS (S-EAS) decided ACR procedure. As shown, the S-EAS performs ACR detection (by itself or by utilizing EES service) at 3.1, and makes the decision for ACR at 3.2. Then at 3.3, the S-EAS triggers a T-EAS discovery procedure and determines the T-EAS to use. At 3.4, a Source EES (S-EES) sends a target information notification to an EEC. At 3.5, the S-EAS transfers the application context to the T-EAS selected at 3.3. Finally, all required entities perform clean-up at 3.6. For further details of the S-EAS decided ACR procedure, reference can be made to Section 8.8.2.4 of TS 23.558 and description thereof will be omitted here.

The T-EAS discovery procedure at 3.3 is described in further detail with reference to FIG. 4. As shown, at 4.1, the S-EAS sends an EAS discovery request to the S-EES. At 4.2, the S-EES checks whether the requesting EAS is authorized to perform the discovery operation. If the S-EES finds the T-EAS(s) in the cached or registered information, the flow continues with step 4.5, or otherwise the S-EES retrieves a Target EES (T-EES) address from an ECS and continues with step 4.3. At 4.3, the S-EES invokes the EAS discovery request on the T-EES. At 4.4, the T-EES discovers the T-EAS(s) and responds with the discovered T-EAS information to the S-EES. At 4.5, the S-EES responds to the S-EAS with the T-EAS Information. For further details of the T-EAS discovery procedure, reference can be made to Section 8.8.3.2 of TS 23.558 and description thereof will be omitted here.

The target information notification procedure at 3.4 is described in further detail with reference to FIG. 5. As shown, at 5.1, the S-EES sends a target information notification message to the EEC. The target information notification message includes the details of the selected T-EAS and T-EES. At 5.2, the EEC responds with the target information notification acknowledgement message.

### SUMMARY

As described above, at 3.4 of FIGS. 3 and 5.1 of FIG. 5, the S-EES sends to the EEC the target information notification message containing information on the selected T-EAS. In the case of the S-EAS triggered T-EAS discovery (in the S-EAS decided ACR scenario), the S-EAS determines the T-EAS from a list of discovered T-EAS (which may be associated with more than one T-EES). In this case, the S-EES cannot determine which of the discovered T-EASs is selected as the T-EAS by the S-EAS and thus cannot provide the EEC with the information on the selected T-EAS in the target information notification message.

It is an object of the present disclosure to provide network nodes and methods therein, capable of solving at least one of the above problems.

According to a first aspect of the present disclosure, a method in a source EAS is provided. The method includes: transmitting a request for EAS discovery to a source EES. The method further includes: receiving, from the source EES, a response containing information indicating one or more discovered EASs. The method further includes: selecting one of the one or more discovered EASs as a target EAS. The method further includes: transmitting information indicating the selected target EAS to the source EES.

In an embodiment, the step of transmitting the information indicating the selected target EAS may include transmitting an identifier of the selected target EAS and/or an endpoint of the selected target EAS.

In an embodiment, the information indicating the selected target EAS may be transmitted in a request to notify the source EES of the selected target EAS.

In an embodiment, the method may further include: receiving, from the source EES, a response to the request to notify the source EES of the selected target EAS.

According to a second aspect of the present disclosure, a method in a source EES is provided. The method includes: receiving, from a source EAS, a request for EAS discovery. The method further includes: transmitting, to the source EAS, a response containing information indicating one or more discovered EASs. The method further includes: receiving, from the source EAS, information indicating a selected target EAS, the selected target EAS being determined or selected from the one or more discovered EASs.

In an embodiment, the step of receiving the information indicating the selected target EAS may include receiving an identifier of the selected target EAS and/or an endpoint of the selected target EAS.

In an embodiment, the information indicating the selected target EAS may be received in a request to notify the source EES of the selected target EAS.

In an embodiment, the method may further include: determining that the source EAS is authorized to transmit the request to notify the source EES of the selected target EAS; and transmitting, to the source EES, a response to the request to notify the source EES of the selected target EAS.

In an embodiment, the method may further include: transmitting the information indicating the selected target EAS to an EEC.

In an embodiment, the method may further include: determining information indicating a target EES based on the information indicating the selected target EAS. The method may further include: transmitting the information indicating the target EES to the EEC.

According to a third aspect of the present disclosure, a method in a source EAS is provided. The method includes: transmitting a request for EAS discovery to a source EES. The request contains an indication of delegation of target EAS selection. The method further includes: receiving, from the source EES, a response containing information indicating a selected target EAS.

In an embodiment, the information indicating the selected target EAS may be included in an Information Element (IE) of Discovered EAS list.

According to a fourth aspect of the present disclosure, a method in a source EES is provided. The method includes: receiving, from a source EAS, a first request for EAS discovery. The first request contains an indication of delegation of EAS selection. The method further includes: selecting a target EAS based on the first request. The method further includes: transmitting, to the source EAS, a first response containing information indicating the target EAS.

In an embodiment, the operation of selecting may include: determining, when the source EES has information indicating one or more EASs that match one or more EAS discovery filters in the first request, one of the one or more EASs as the target EAS.

In an embodiment, the method may further include, when the source EES has no information indicating any EAS that matches the one or more EAS discovery filters in the first request: transmitting, to each of one or more target EESs, a second request for EAS discovery based on the first request, and receiving, from each of at least one of the one or more target EESs, a second response containing information indicating one or more EASs. The operation of selecting may include:

determining, from a set of EASs obtained by combining the one or more EASs from each of the at least one target EESs, an EAS as the target EAS.

In an embodiment, the second request transmitted to at least a first target EES out of the one or more target EESs may contain an indication of delegation of EAS selection, and the second response from the first target EES may contain information indicating one EAS selected by the first target EES.

In an embodiment, the method may further include: transmitting, to an EEC, the information indicating the target EAS, or the information indicating the target EAS and information indicating a target EES associated with the target EAS.

In an embodiment, the method may further include: transmitting the information indicating the target EAS and information indicating the target EES associated with the target EAS to an EEC.

In an embodiment, the information indicating the selected target EAS is included in an IE of Discovered EAS list.

According to a fifth aspect of the present disclosure, a method in a target EES is provided. The method includes: receiving, from a source EES, a request for EAS discovery. The request contains an indication of delegation of EAS selection. The method further includes: selecting an EAS based on the request. The method further includes: transmitting, to the source EES, a response containing information indicating the selected EAS.

In an embodiment, the information indicating the selected EAS may be included in an IE of Discovered EAS list.

According to a sixth aspect of the present disclosure, a network node is provided. The network node includes a communication interface, a processor and a memory.

The memory contains instructions executable by the processor whereby the network node is operative to, when implementing a source EAS, perform the method according to the above first or third aspect, or when implementing a source EES, perform the method according to the above second or fourth aspect, or when implementing a target EES, perform the method according to the above fifth aspect.

According to a seventh aspect of the present disclosure, a computer-readable storage medium is provided. The computer-readable storage medium has computer-readable instructions stored thereon. The computer-readable instructions, when executed by a processor of a network node, configure the network node to, when implementing a source EAS, perform the method according to the above first or third aspect, or when implementing a source EES, perform the method according to the above second or fourth aspect, or when implementing a target EES, perform the method according to the above fifth aspect.

With the embodiments of the present disclosure, a source EAS can transmit information on a target EAS determined or selected by the source EAS to a source EES, or the source EAS can delegate target EAS selection to the source EES. In either case, the source EES is aware of the selected target EAS, and can thus transmit the information on the target EAS to an EEC.

### BRIEF DESCRIPTION OF THE DRAWINGS

The above and other objects, features and advantages will be more apparent from the following description of embodiments with reference to the figures, in which:

FIG. 1 is a schematic diagram showing an architecture for enabling edge applications;

FIGS. 2A and 2B are schematic diagrams showing inter-EDN and intra-EDN EDGE-9 reference points, respectively;

FIG. 3 is a sequence diagram of an S-EAS decided ACR procedure;

FIG. 4 is a sequence diagram of a T-EAS discovery procedure;

FIG. 5 is a sequence diagram of a target information notification procedure;

FIG. 6 is a flowchart illustrating a method in an S-EAS according to an embodiment of the present disclosure;

FIG. 7 is a flowchart illustrating a method in an S-EES according to an embodiment of the present disclosure;

FIG. 8 is a sequence diagram showing an exemplary T-EAS discovery procedure according to an embodiment of the present disclosure;

FIG. 9 is a sequence diagram showing an exemplary T-EAS notification procedure according to an embodiment of the present disclosure;

FIG. 10 is a flowchart illustrating a method in an S-EAS according to another embodiment of the present disclosure;

FIG. 11 is a flowchart illustrating a method in an S-EES according to another embodiment of the present disclosure;

FIG. 12 is a flowchart illustrating a method in a T-EES according to another embodiment of the present disclosure;

FIG. 13 is a sequence diagram showing an exemplary T-EAS discovery procedure according to another embodiment of the present disclosure;

FIG. 15 is a block diagram of a network node according to an embodiment of the present disclosure;

FIG. 16 is a block diagram of a network node according to another embodiment of the present disclosure;

FIG. 17 is a block diagram of a network node according to yet another embodiment of the present disclosure;

FIG. 18 is a block diagram of a network node according to still another embodiment of the present disclosure; and

FIG. 19 is a block diagram of a network node according to still yet another embodiment of the present disclosure.

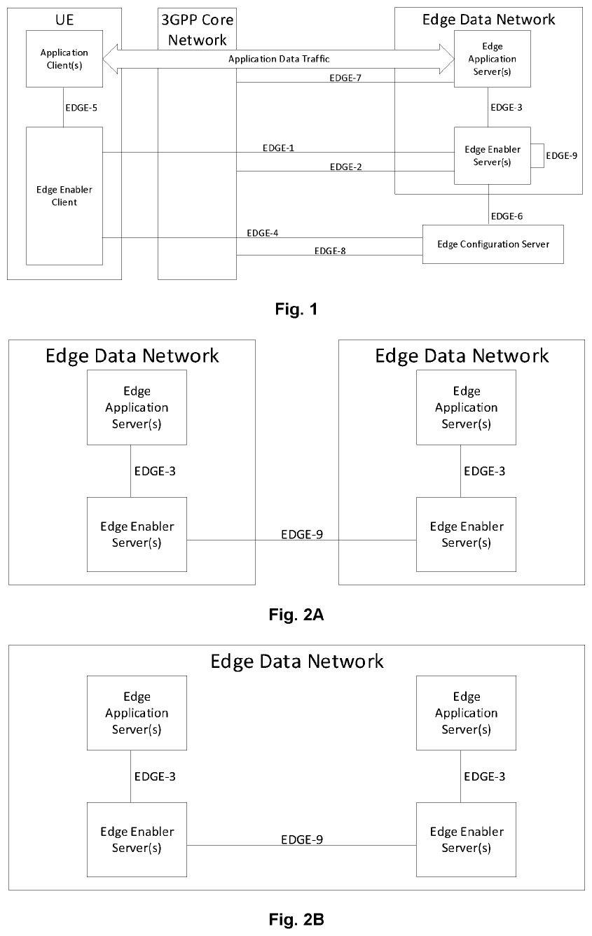

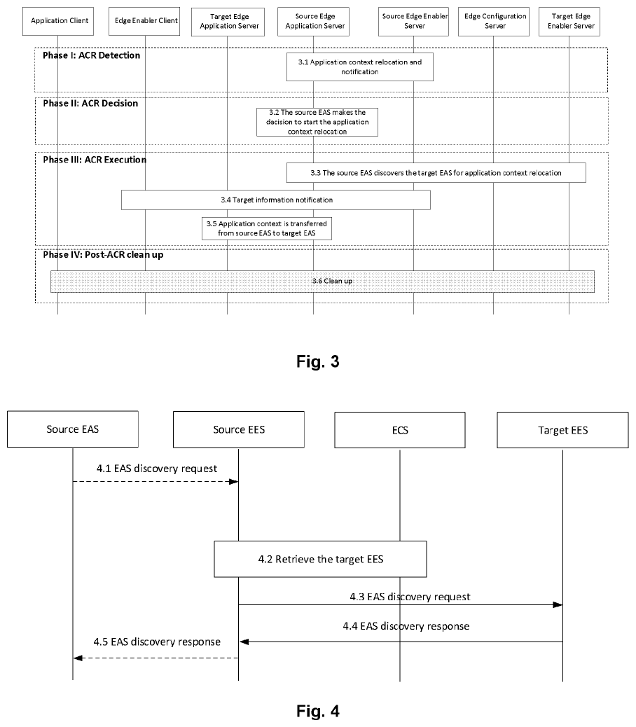

### DETAILED DESCRIPTION

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

FIG. 6 is a flowchart illustrating a method 600 according to an embodiment of the present disclosure. The method 600 can be performed at a source EAS (S-EAS).

At block 610, a request for EAS discovery (e.g., EAS discovery request in FIG. 4) is transmitted to a source EES.

At block 620, a response (e.g., EAS discovery response in FIG. 4) containing information indicating one or more discovered EASs (EAS(s) found in cached or registered information at the source EES and/or EAS(s) discovered by means of EAS discovery towards one or more target EESs) is received from the source EES.

At block 630, one of the one or more discovered EASs is determined or selected as a target EAS.

At block 640, information indicating the selected target EAS is transmitted to the source EES. Here, the information indicating the selected target EAS may include an identifier of the selected target EAS and/or an endpoint of the selected target EAS.

In an example, the information indicating the selected target EAS may be transmitted in a request to notify the source EES of the selected target EAS. The source EAS may further receive, from the source EES, a response to the request to notify the source EES of the selected target EAS.

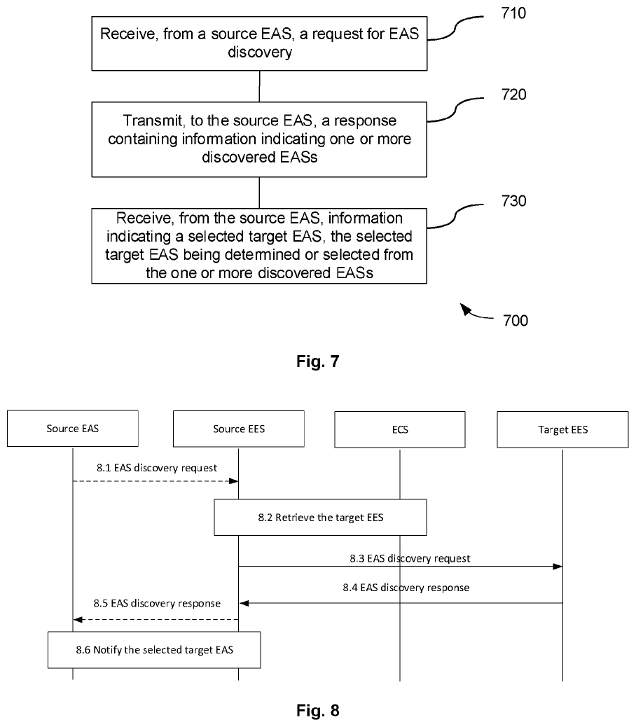

FIG. 7 is a flowchart illustrating a method 700 according to an embodiment of the present disclosure. The method 700 can be performed at a source EES (S-EES).

At block 710, a request for EAS discovery (e.g., EAS discovery request in FIG. 4) is received from a source EAS.

At block 720, a response (e.g., EAS discovery response in FIG. 4) containing information indicating one or more discovered EASs is transmitted to the source EAS.

At block 730, information indicating a selected target EAS, the selected target EAS being determined or selected from the one or more discovered EASs (EAS(s) found in cached or registered information at the source EES and/or EAS(s) discovered by means of EAS discovery towards one or more target EESs) is received from the source EAS. Here, the information indicating the selected target EAS may include an identifier of the selected target EAS and/or an endpoint of the selected target EAS.

In an example, the information indicating the selected target EAS may be received in a request to notify the source EES of the selected target EAS. The source EES may determine that the source EAS is authorized to transmit the request to notify the source EES of the selected target EAS, and transmit, to the source EES, a response to the request to notify the source EES of the selected target EAS.

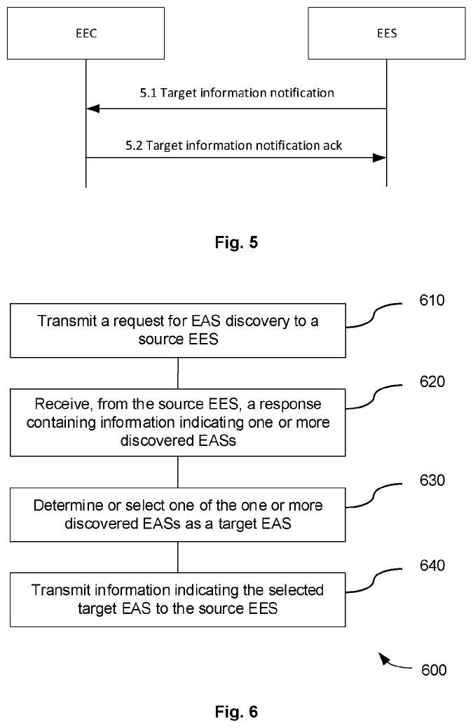

In an example, the source EES may transmit the information indicating the selected target EAS to an EEC (e.g., in target information notification at 5.1 in FIG. 5).

In another example, the source EES may determine information indicating a target EES based on the information indicating the selected target EAS, and transmit the information indicating the target EES to the EEC (e.g., in target information notification at 5.1 in FIG. 5).

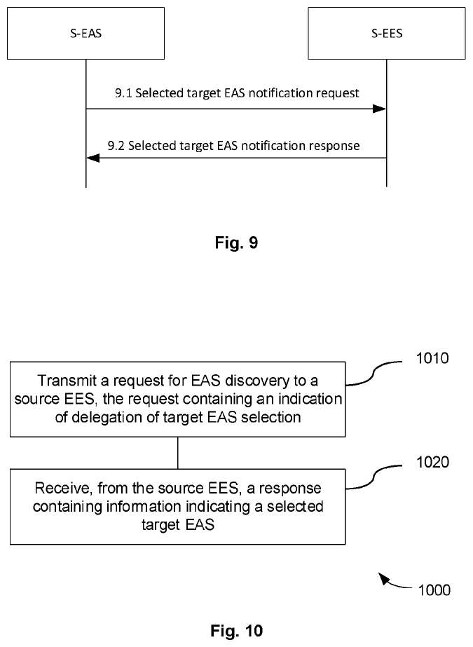

The methods 600 and 700 will be further explained with reference to FIGS. 8 and 9.

FIG. 8 shows a T-EAS discovery procedure according to an embodiment of the present disclosure. The operations at 8.1˜8.5 in FIG. 8 are substantially the same as the operations at 4.1˜4.5 described above in connection with FIG. 4. At 8.6, after the source EAS selects the target EAS from the discovered T-EAS information received at 8.5, the source EAS notifies the source EES of the selected target EAS, e.g., by using the T-EAS notification procedure shown in FIG. 9. As shown in FIG. 9, at 9.1, the source EAS transmits a selected target EAS notification request to the source EES. The request contains information on the selected target EAS. At 9.2, the source EES checks whether the requesting EAS is authorized to perform the operation. If so, the source EES responds to the received request with a selected target EAS notification response message. The source EES also determines the selected target EES based on the notified selected target EAS, which may be contained in the target information notification sent to the EEC.

The selected target EAS notification request may contain Information Elements (IEs) shown in Table 1 below:

TABLE 1
Selected target EAS notification request

| Information element | Status | Description |
|---|---|---|
| UE ID | M | The identifier of the UE. |
| Security credentials | M | Security credentials of the EEC. |
| Selected EAS ID | M | Selected EAS identifier. |
| Selected EAS Endpoint | M | Endpoint of the selected EAS. |

The selected target EAS notification response may contain Information Elements (IEs) shown in Table 2 below:

TABLE 2
Selected target EAS notification response

| Information element | Status | Description |
|---|---|---|
| Successful response | O | Indicates that the request |
| | | was successful. |
| Failure response | O | Indicates that the request failed. |
| >Cause | O | Indicates the failure cause. |

Accordingly, an Application Programming Interface (API) operation, NotifySelectedEAS, can be added to the ACR API, Eees_TargetEASDiscovery, as shown in Table 3 below:

TABLE 3
ACR APIs

| API | API | Operation | Con- |
|---|---|---|---|
| Name | Operations | Semantics | sumer(s) |
| Eees_TargetEASDiscovery | NotifySelectedEAS | Request/ | EAS |
| | | Response | |

API operation name: Eees_TargetEASDiscovery_NotifySelectedEAS
Description: The consumer notifies the EES with the selected T-EAS information.
Inputs: See Selected target EAS notification request
Outputs: See Selected target EAS notification response

Alternatively, a standalone API can be used for the selected target EAS notification.

FIG. 10 is a flowchart illustrating a method 1000 according to another embodiment of the present disclosure. The method 1000 can be performed at a source EAS (S-EAS).

At block 1010, a request for EAS discovery (e.g., EAS discovery request) is transmitted to a source EES. The request contains an indication of delegation of target EAS selection.

At block 1020, a response (e.g., EAS discovery response) containing information indicating a selected target EAS is received from the source EES. Here, the information indicating the selected target EAS may be included in an IE of Discovered EAS list or in a new IE.

FIG. 11 is a flowchart illustrating a method 1100 according to another embodiment of the present disclosure. The method 1100 can be performed at a source EES (S-EES).

At block 1110, a first request for EAS discovery (e.g., EAS discovery request) is received from a source EAS. The first request contains an indication of delegation of EAS selection.

At block 1120, a target EAS is selected based on the first request, e.g., in accordance with the indication of delegation of EAS selection.

For example, in the block 1120, when the source EES has (registered or cached) information indicating one or more EASs that match one or more EAS discovery filters in the first request, one of the one or more EASs can be selected as the target EAS.

In another example, when the source EES has no (registered or cached) information indicating any EAS that matches the one or more EAS discovery filters in the first request, the source EES can transmit, to each of one or more target EESs, a second request for EAS discovery (e.g., EAS discovery request) based on the first request, and then receive, from each of at least one of the one or more target EESs, a second response (e.g., EAS discovery response) containing information indicating one or more EASs. In the block 1120, the source EES can determine, from a set of EASs obtained by combining the one or more EASs from each of the at least one target EESs, an EAS as the target EAS. Here, the second request transmitted to at least a first target EES out of the one or more target EESs may contain an indication of delegation of EAS selection, and the second response from the first target EES may contain information indicating one EAS selected by the first target EES (e.g., based on the EAS discovery filter(s)).

At block 1130, a first response (e.g., EAS discovery response) containing information indicating the target EAS is transmitted to the source EAS.

In an example, the source EES can transmit, to an EEC, the information indicating the target EAS, and possibly information indicating a target EES associated with the target EAS. For instance, when the target EAS is connected to, or associated with, the source EES (or in other words when the target EES is the same as the source EES), the source EES may or may not transmit the information indicating the target EES (source EES) to the EEC along with the information indicating the target EAS.

In an example, the information indicating the selected target EAS may be included in an IE of Discovered EAS list or in a new IE.

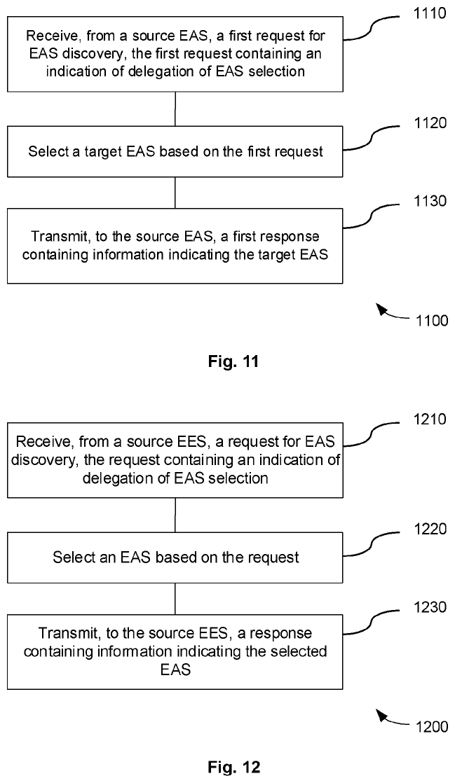

FIG. 12 is a flowchart illustrating a method 1200 according to another embodiment of the present disclosure. The method 1200 can be performed at a target EES (T-EES).

At block 1210, a request for EAS discovery (e.g., EAS discovery request) is received from a source EES. The request contains an indication of delegation of EAS selection.

At block 1220, an EAS is selected based on the request, e.g., based on one or more EAS discovery filters in the request, in accordance with the indication of delegation of EAS selection.

At block 1230, a response containing information indicating the selected EAS is transmitted to the source EES. Here, the information indicating the selected EAS may be included in an IE of Discovered EAS list.

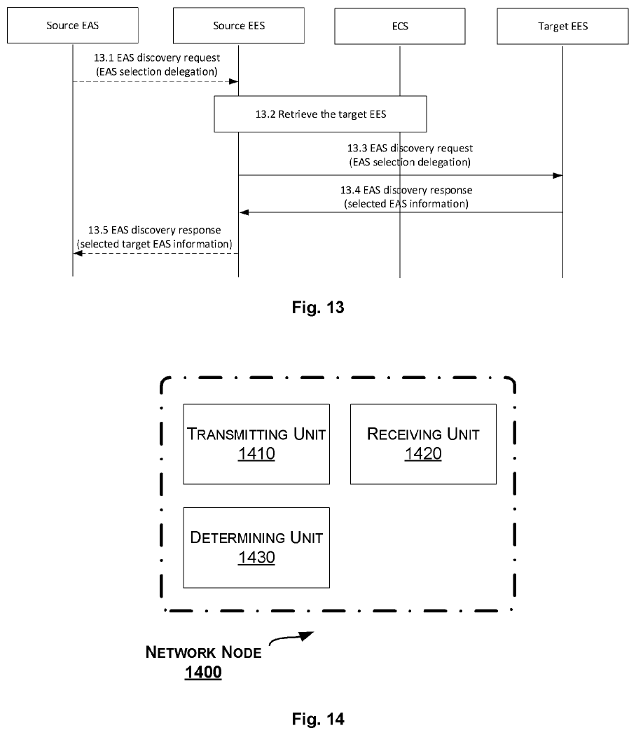

The methods 1000˜1200 will be further explained with reference to FIG. 13, which shows a T-EAS discovery procedure according to another embodiment of the present disclosure. As shown in FIG. 13, at 13.1, the S-EAS sends an EAS discovery request to the S-EES. The EAS discovery request contains an EAS selection delegation indication, as shown in Table 4 below:

TABLE 4
EAS discovery request

| Information element | Status | Description |
|---|---|---|
| Requestor | M | The ID of the requestor |
| identifier | | (e.g. EASID or EESID) |
| UE identifier | O | The identifier of the UE |
| | | (i.e. GPSI or identity token). |
| Security | M | Security credentials resulting |
| credentials | | from a successful authorization for |
| | | the edge computing service. |
| EAS Discovery | M | Set of characteristics to determine |
| Filters | | required EASs, as detailed in Table |
| | | 8.5.3.2-2. |
| UE location | O | The location information of the UE. |
| | | The UE location is described as |
| | | clause 7.3.2. |
| Target DNAI | O | Target DNAI information which |
| | | can be associated with |
| | | potential T-EAS(s) |
| EAS selection delegation | O | Indicates whether the S-EES |
| indication | | or T-EES can select T-EAS from |
| | | the discovered T-EAS list. |

For further details of the IEs in the EAS discovery request, reference can be made to Table 8.8.4.2-1 of TS 23.558.

At 13.2, if the S-EES finds one or more EAS(s) in the cached or registered information, the flow continues with step 13.5; or otherwise the S-EES retrieves a T-EES address from an ECS and continues with step 13.3. At 13.3, the S-EES invokes the EAS discovery request on the T-EES. For example, the S-EES can send an EAS discovery request containing an EAS selection delegation indication to the T-EES. At 13.4, the T-EES discovers EAS(s), selects an EAS from the discovered EAS(s), and responds with information indicating the selected EAS to the S-EES. Alternatively, if the EAS discovery request received at 13.3 does not contain the EAS selection delegation indication, the T-EES can discover EAS(s) and respond with information indicating the discovered EAS(s) to the S-EES at 13.4.

At 13.5, the S-EES selects a T-EAS from the EAS(s) found in the cached or registered information or from the EAS(s) indicated in the information indicating the selected EAS or the information indicating the discovered EAS(s) from one or more T-EESs, based on EAS discovery filters in the EAS discovery request received at 13.1, and responds to the S-EAS with the selected T-EAS Information.

Correspondingly to the method 600 as described above, a network node is provided. FIG. 14 is a block diagram of a network node 1400 according to an embodiment of the present disclosure. The network node 1400 can be configured to implement a source EAS.

As shown in FIG. 14, the network node 1400 includes a transmitting unit 1410 configured to transmit a request for EAS discovery to a source EES. The network node 1400 further includes a receiving unit 1420 configured to receive, from the source EES, a response containing information indicating one or more discovered EASs. The network node 1400 further includes a determining unit 1430 configured to determine or select one of the one or more discovered EASs as a target EAS. The transmitting unit 1410 is further configured to transmit information indicating the selected target EAS to the source EES.

In an embodiment, the transmitting unit 1410 may be further configured to transmit, to the source EES, an identifier of the selected target EAS and/or an endpoint of the selected target EAS.

In an embodiment, the information indicating the selected target EAS may be transmitted in a request to notify the source EES of the selected target EAS.

In an embodiment, the receiving unit 1420 may be further configured to receive, from the source EES, a response to the request to notify the source EES of the selected target EAS.

The units 1410˜1430 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 6.

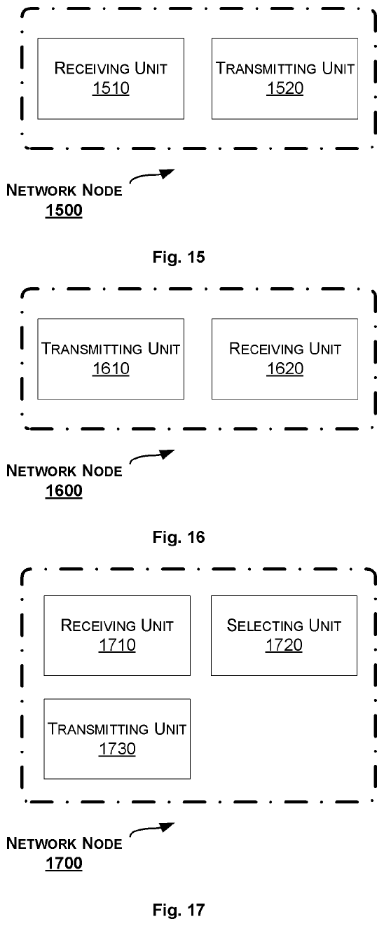

Correspondingly to the method 700 as described above, a network node is provided. FIG. 15 is a block diagram of a network node 1500 according to an embodiment of the present disclosure. The network node 1500 can be configured to implement a source EES.

As shown in FIG. 15, the network node 1500 includes a receiving unit 1510 configured to receive, from a source EAS, a request for EAS discovery. The network node 1500 further includes a transmitting unit 1520 configured to transmit, to the source EAS, a response containing information indicating one or more discovered EASs. The receiving unit 1510 is further configured to receive, from the source EAS, information indicating a selected target EAS, the selected target EAS being determined or selected from the one or more discovered EASs.

In an embodiment, the receiving unit 1510 may be further configured to receive, from the source EAS, an identifier of the selected target EAS and/or an endpoint of the selected target EAS.

In an embodiment, the information indicating the target EAS may be received in a request to notify the source EES of the selected target EAS.

In an embodiment, the network node 1500 may further include a determining unit configured to determine that the source EAS is authorized to transmit the request to notify the source EES of the selected target EAS. The transmitting unit 1520 may be configured to transmit, to the source EES, a response to the request to notify the source EES of the selected target EAS.

In an embodiment, the transmitting unit 1520 may be configured to transmit the information indicating the selected target EAS to an EEC.

In an embodiment, the network node 1500 may further include a determining unit configured to determine information indicating a target EES based on the information indicating the selected target EAS. The transmitting unit 1520 may be configured to transmit the information indicating the target EES to the EEC.

The units 1510˜1520 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 7.

Correspondingly to the method 1000 as described above, a network node is provided. FIG. 16 is a block diagram of a network node 1600 according to an embodiment of the present disclosure. The network node 1600 can be configured to implement a source EAS.

As shown in FIG. 16, the network node 1600 includes a transmitting unit 1610 configured to transmit a request for EAS discovery to a source EES. The request contains an indication of delegation of target EAS selection. The network node 1600 further includes a receiving unit 1620 configured to receive, from the source EES, a response containing information indicating a selected target EAS.

In an embodiment, the information indicating the selected target EAS may be included in an IE of Discovered EAS list.

The units 1610˜1620 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 10.

Correspondingly to the method 1100 as described above, a network node is provided. FIG. 17 is a block diagram of a network node 1700 according to an embodiment of the present disclosure. The network node 1700 can be configured to implement a source EES.

As shown in FIG. 17, the network node 1700 includes a receiving unit 1710 configured to receive, from a source EAS, a first request for EAS discovery. The first request contains an indication of delegation of EAS selection. The network node 1700 further includes a selecting unit 1720 configured to select a target EAS based on the first request. The network node 1700 further includes a transmitting unit 1730 configured to transmit, to the source EAS, a first response containing information indicating the target EAS.

In an embodiment, the selecting unit 1720 may be configured to determine, when the source EES has information indicating one or more EASs that match one or more EAS discovery filters in the first request, one of the one or more EASs as the target EAS.

In an embodiment, when the source EES has no information indicating any EAS that matches the one or more EAS discovery filters in the first request, the transmitting unit 1730 may be further configured to transmit, to each of one or more target EESs, a second request for EAS discovery based on the first request, and the receiving unit 1710 may be further configured to receive, from each of at least one of the one or more target EESs, a second response containing information indicating one or more EASs. The selecting unit 1720 may be configured to determine, from a set of EASs obtained by combining the one or more EASs from each of the at least one target EESs, an EAS as the target EAS.

In an embodiment, the second request transmitted to at least a first target EES out of the one or more target EESs may contain an indication of delegation of EAS selection, and the second response from the first target EES may contain information indicating one EAS selected by the first target EES.

In an embodiment, the transmitting unit 1730 may be further configured to transmit, to an EEC, the information indicating the target EAS, or the information indicating the target EAS and information indicating a target EES associated with the target EAS.

In an embodiment, the transmitting unit 1730 may be further configured to transmit the information indicating the target EAS and information indicating the target EES associated with the target EAS to an EEC.

In an embodiment, the information indicating the selected target EAS is included in an IE of Discovered EAS list.

The units 1710˜1730 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 11.

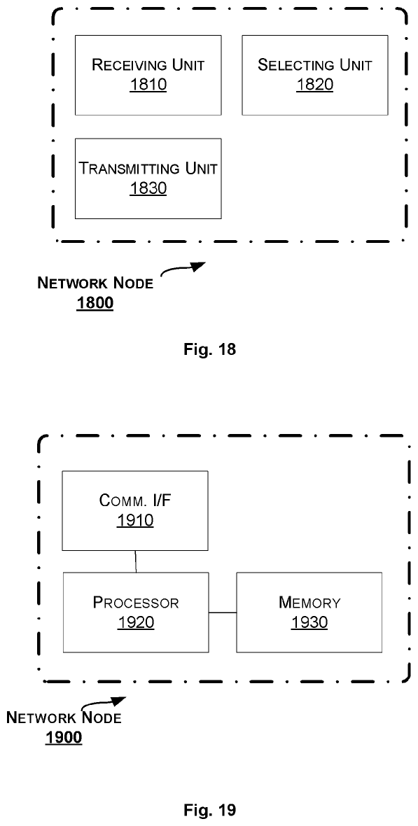

Correspondingly to the method 1200 as described above, a network node is provided. FIG. 18 is a block diagram of a network node 1800 according to an embodiment of the present disclosure. The network node 1800 can be configured to implement a target EES.

As shown in FIG. 18, the network node 1800 includes a receiving unit 1810 configured to receive, from a source EES, a request for EAS discovery. The request contains an indication of delegation of EAS selection. The network node 1800 further includes a selecting unit 1820 configured to select an EAS based on the request. The network node 1800 further includes a transmitting unit 1830 configured to transmit, to the source EES, a response containing information indicating the selected EAS.

In an embodiment, the information indicating the selected EAS may be included in an IE of Discovered EAS list.

The units 1810˜1830 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 12.

FIG. 19 is a block diagram of a network node 1900 according to another embodiment of the present disclosure.

The network node 1900 includes a communication interface 1910, a processor 1920 and a memory 1930.

The memory 1930 may contain instructions executable by the processor 1920 whereby the network node 1900 is operative to, when implementing a source EAS, perform the actions, e.g., of the procedure described earlier in conjunction with FIG. 6. Particularly, the memory 1930 may contain instructions executable by the processor 1900 whereby the network node 1900 is operative to, when implementing a source EAS: transmit a request for EAS discovery to a source EES: receive, from the source EES, a response containing information indicating one or more discovered EASs; determine or select one of the one or more discovered EASs as a target EAS; and transmit information indicating the selected target EAS to the source EES.

In an embodiment, the memory 1930 may further contain instructions executable by the processor 1900 whereby the network node 1900 is operative to, transmit, to the source EEs, an identifier of the selected target EAS and/or an endpoint of the selected target EAS.

In an embodiment, the information indicating the selected target EAS may be transmitted in a request to notify the source EES of the selected target EAS.

In an embodiment, the memory 1930 may further contain instructions executable by the processor 1900 whereby the network node 1900 is operative to, when implementing the source EAS: receive, from the source EES, a response to the request to notify the source EES of the selected target EAS.

Alternatively, the memory 1930 may contain instructions executable by the processor 1920 whereby the network node 1900 is operative to, when implementing a source EES, perform the actions, e.g., of the procedure described earlier in conjunction with FIG. 7. Particularly, the memory 1930 may contain instructions executable by the processor 1900 whereby the network node 1900 is operative to, when implementing a source EES: receive, from a source EAS, a request for EAS discovery; transmit, to the source EAS, a response containing information indicating one or more discovered EASs; and receive, from the source EAS, information indicating a selected target EAS, the selected target EAS being determined or selected from the one or more discovered EASs.

In an embodiment, the memory 1930 may further contain instructions executable by the processor 1900 whereby the network node 1900 is operative to, receive, from the source EAS, an identifier of the selected target EAS and/or an endpoint of the selected target EAS.

In an embodiment, the information indicating the selected target EAS may be received in a request to notify the source EES of the selected target EAS.

In an embodiment, the memory 1930 may further contain instructions executable by the processor 1900 whereby the network node 1900 is operative to, when implementing the source EES: determine that the source EAS is authorized to transmit the request to notify the source EES of the selected target EAS; and transmit, to the source EES, a response to the request to notify the source EES of the selected target EAS.

In an embodiment, the memory 1930 may further contain instructions executable by the processor 1900 whereby the network node 1900 is operative to, when implementing the source EES: transmit the information indicating the selected target EAS to an EEC.

In an embodiment, the memory 1930 may further contain instructions executable by the processor 1900 whereby the network node 1900 is operative to, when implementing the source EES: determine information indicating a target EES based on the information indicating the selected target EAS; and transmit the information indicating the target EES to the EEC.

Alternatively, the memory 1930 may contain instructions executable by the processor 1920 whereby the network node 1900 is operative to, when implementing a source EAS, perform the actions, e.g., of the procedure described earlier in conjunction with FIG. 10. Particularly, the memory 1930 may contain instructions executable by the processor 1900 whereby the network node 1900 is operative to, when implementing a source EAS: transmit a request for EAS discovery to a source EES, the request containing an indication of delegation of target EAS selection; and receive, from the source EES, a response containing information indicating a selected target EAS.

In an embodiment, the information indicating the selected target EAS may be included in an IE of Discovered EAS list.

Alternatively, the memory 1930 may contain instructions executable by the processor 1920 whereby the network node 1900 is operative to, when implementing a source EES, perform the actions, e.g., of the procedure described earlier in conjunction with FIG. 11. Particularly, the memory 1930 may contain instructions executable by the processor 1900 whereby the network node 1900 is operative to, when implementing a source EES: receive, from a source EAS, a first request for EAS discovery, the first request containing an indication of delegation of EAS selection; select a target EAS based on the first request; and transmit, to the source EAS, a first response containing information indicating the target EAS.

In an embodiment, the operation of selecting may include: determining, when the source EES has information indicating one or more EASs that match one or more EAS discovery filters in the first request, one of the one or more EASs as the target EAS.

In an embodiment, when the source EES has no information indicating any EAS that matches the one or more EAS discovery filters in the first request, the memory 1930 may further contain instructions executable by the processor 1900 whereby the network node 1900 is operative to, when implementing the source EES: transmit, to each of one or more target EESs, a second request for EAS discovery based on the first request, and receive, from each of at least one of the one or more target EESs, a second response containing information indicating one or more EASs. The operation of selecting may include determining, from a set of EASs obtained by combining the one or more EASs from each of the at least one target EESs, an EAS as the target EAS.

In an embodiment, the second request transmitted to at least a first target EES out of the one or more target EESs may contain an indication of delegation of EAS selection, and the second response from the first target EES may contain information indicating one EAS selected by the first target EES.

In an embodiment, the memory 1930 may further contain instructions executable by the processor 1900 whereby the network node 1900 is operative to, when implementing the source EES: transmit, to an EEC, the information indicating the target EAS, or the information indicating the target EAS and information indicating a target EES associated with the target EAS.

In an embodiment, the memory 1930 may further contain instructions executable by the processor 1900 whereby the network node 1900 is operative to, when implementing the source EES: transmit the information indicating the target EAS and information indicating the target EES associated with the target EAS to an EEC.

In an embodiment, the information indicating the selected target EAS is included in an IE of Discovered EAS list.

Alternatively, the memory 1930 may contain instructions executable by the processor 1920 whereby the network node 1900 is operative to, when implementing a target EES, perform the actions, e.g., of the procedure described earlier in conjunction with FIG. 12. Particularly, the memory 1930 may contain instructions executable by the processor 1900 whereby the network node 1900 is operative to, when implementing a target EES: receive, from a source EES, a request for EAS discovery, the request containing an indication of delegation of EAS selection; select an EAS based on the request; and transmit, to the source EES, a response containing information indicating the selected EAS.

In an embodiment, the information indicating the selected EAS may be included in an IE of Discovered EAS list.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1920 causes the network node 1900 to perform the actions, e.g., of the procedure described earlier in conjunction with FIG. 6, 7, 10, 11, or 12.

The computer program product may be configured as a computer program code structured in computer program modules. The computer program modules could essentially perform the actions of the flow illustrated in FIG. 6, 7, 10, 11, or 12.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried in a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1-23. (canceled)

24. A method in a source Edge Application Server (EAS), the method comprising:
transmitting a request for EAS discovery to a source Edge Enabler Server (EES);
receiving, from the source EES, a response containing information indicating one or more discovered EASs;
selecting one of the one or more discovered EASs as a target EAS; and
transmitting information indicating the selected target EAS to the source EES.

25. The method of claim 24, wherein the step of transmitting the information indicating the selected target EAS comprises including an identifier of the selected target EAS and/or an endpoint of the selected target EAS.

26. The method of claim 24, wherein the information indicating the selected target EAS is transmitted in a request to notify the source EES of the selected target EAS.

27. The method of claim 26, further comprising:
receiving, from the source EES, a response to the request to notify the source EES of the selected target EAS.

28. A non-transitory computer-readable storage medium comprising, stored thereupon, computer-readable instructions stored, the computer-readable instructions being configured so that, when executed by a processor of a network node, the computer-readable instructions configure the network node to, when implementing a source Edge Application Server (EAS), perform the method of claim 24.

29. A method in a source Edge Enabler Server (EES), the method comprising:
receiving, from a source Edge Application Server (EAS), a request for EAS discovery;
transmitting, to the source EAS, a response containing information indicating one or more discovered EASs; and
receiving, from the source EAS, information indicating a selected target EAS, the selected target EAS being selected from the one or more discovered EASs.

30. The method of claim 28, wherein the step of receiving the information indicating the selected target EAS comprises receiving an identifier of the selected target EAS and/or an endpoint of the selected target EAS.

31. The method of claim 29, wherein the information indicating the selected target EAS is received in a request to notify the source EES of the selected target EAS.

32. The method of claim 31, further comprising:
determining that the source EAS is authorized to transmit the request to notify the source EES of the selected target EAS; and
transmitting, to the source EES, a response to the request to notify the source EES of the selected target EAS.

33. The method of claim 29, further comprising:
transmitting the information indicating the selected target EAS to an Edge Enabler Client (EEC).

34. The method of claim 33, further comprising:
determining information indicating a target EES based on the information indicating the selected target EAS; and
transmitting the information indicating the target EES to the EEC.

35. A non-transitory computer-readable storage medium comprising, stored thereupon, computer-readable instructions stored, the computer-readable instructions being configured so that, when executed by a processor of a network node, the computer-readable instructions configure the network node to, when implementing a source Edge Enable Server (EAS), perform the method of claim 29.

36. A network node, comprising a communication interface, a processor and a memory, the memory comprising instructions executable by the processor whereby the network node is operative to, when implementing a source Edge Application Server (EAS):
transmit a request for EAS discovery to a source Edge Enabler Server (EES);
receive, from the source EES, a response containing information indicating one or more discovered EASs;
select one of the one or more discovered EASs as a target EAS; and
transmit information indicating the selected target EAS to the source EES.

37. A network node, comprising a communication interface, a processor and a memory, the memory comprising instructions executable by the processor whereby the network node is operative to, when implementing a source Edge Enabler Server (EES):
receive, from a source Edge Application Server (EAS), a request for EAS discovery;
transmit, to the source EAS, a response containing information indicating one or more discovered EASs; and
receive, from the source EAS, information indicating a selected target EAS, the selected target EAS being selected from the one or more discovered EASs.
